(19) United States
(12) Patent Application Publication
(10) Pub. No.: US 2006/0224311 A1
(43) Pub. Date: Oct. 5, 2006

(54) Navigation system

(75) Inventors: Yoshinori Watanabe, Obu-city (JP); Motohiro Fukumoto, Nagoya-city (JP)

Correspondence Address: POSZ LAW GROUP, PLC, 12040 SOUTH LAKES DRIVE, SUITE 101, RESTON, VA, 20191, US

(73) Assignee: DENSO CORPORATION, Kariya-city (JP)

(21) Appl. No.: 11/300,267

(22) Filed: Dec. 15, 2005

(30) Foreign Application Priority Data
Dec. 22, 2004 (JP) 2004-372258

(51) Int. Cl. G01C 21/32

(52) U.S. Cl. 701/208; 701/211; 340/995.1

(57) ABSTRACT

A map display system having map data of three dimensions for displaying a three-dimensional map together with a representation of a vector map data includes an elevation acquisition means for acquiring an elevation of a route between a start point to an end point in said three-dimensional map, a position determination means for determining a position of a guidance line in said three-dimensional map based on the elevation of the route, and a map drawing means for drawing said three-dimensional map with the guidance line by using the position of the guidance line. The guidance line is represented along the route in said three-dimensional map by using the vector map data.

### CROSS REFERENCE TO RELATED APPLICATION

This application is based on and claims the benefit of priority of Japanese Patent Application No. 2004-372258 filed on Dec. 22, 2004, the disclosure of which is incorporated herein by reference.

### FIELD OF THE INVENTION

The present invention generally relates to a navigation system.

### BACKGROUND OF THE INVENTION

A map display device is conventionally used to display a map including a building and a road represented in three-dimensional manner as disclosed in Japanese patent documents JP-A-H10-89990 and JP-A-2001-27535.

For example, a guidance line is displayed for navigational purpose in the three-dimensional map in order to distinguishably represent a route to a destination. In this case, data being used to represent the three-dimensional map includes elevation information, that is, ups and downs of the road or the like, for realistic representation. However, data being used to represent the guidance line only includes positional (two-dimensional) information, thereby causing discrepancy or inconsistency between the representation of the road and the guidance line.

### SUMMARY OF THE INVENTION

In view of the above-described and other problems, the present invention provides a navigation system that is equipped with a capability to display a guidance line in a manner that is suitable for geographical features represented in a three-dimensional map.

The navigation system uses map data that includes position and elevation information for two-dimensional representation, polygon information for three-dimensional representation, and vector information for guidance line representation in the map. The navigation information includes an elevation acquisition means, a position determination means, and a map-drawing means. The elevation acquisition means acquires an elevation of a position in the map from the polygon information. The position determination means determines the elevation of the guidance line in the three-dimensional map based on the elevation determined by the elevation acquisition means. The map-drawing means draws the guidance line at the position determined by the position determination means together with the three-dimensional map. In this manner, the guidance line is fittingly drawn on a terrain in the three-dimensional map.

The navigation system of the present invention further includes a node determination means for finding and determining a node in the guidance line such as a highest point, a start point, an end point, and a lowest point. The map-drawing means draws the guidance line in the map at the highest point in elevation, thereby representing the guidance line always above the terrain. The map-drawing means also utilizes other nodes for fittingly draw the guidance line on the terrain in the map.

The navigation system of the present invention divides the map data into a mesh of small areas, and processes one of those areas at a time. That is, the nodes such as the highest/lowest points and the like found in the small area is used to fittingly draws the guidance line in the map. In this manner, process load of the navigation system is decreased.

The navigation system of the present invention determines the nodes at a point where a slope of the terrain along the guidance line turns either from upward to downward, or from downward to upward for fittingly drawing the guidance line.

The guidance line between two nodes may be divided into plural lines for further accommodating the undulations of the terrain in the map.

### BRIEF DESCRIPTION OF THE DRAWINGS

Other objects, features and advantages of the present invention will become more apparent from the following detailed description made with reference to the accompanying drawings, in which:

FIG. 1 shows a block diagram of a navigation system in an embodiment of the present invention;

FIG. 2 shows a block diagram of the control circuit;

FIG. 3 shows a flowchart of a route guidance process;

FIG. 4A shows a cross-sectional view of a route from a start point to a destination point;

FIG. 4B shows a highest point in the route in the cross-sectional view of the route;

FIG. 4C shows a guidance line above a terrain in the cross-sectional view of the route;

FIG. 4D shows the guidance line connecting the start point, the highest point and the destination point in the cross-sectional view of the route;

FIG. 5A shows the highest point and the lowest point in the route in the cross-sectional view of the route;

FIG. 5B shows the guidance line connecting the start point, the highest point, the lowest point and the destination point in the cross-sectional view of the route;

FIG. 6A shows a halfway point of the highest and lowest points in the cross-sectional view of the route;

FIG. 6B shows the halfway point between two points in terms of horizontal distance;

FIG. 6C shows the guidance line connecting the highest, lowest, start, and halfway points as well as the destination point in the cross-sectional view of the route;

FIG. 6D shows the guidance line connecting an increased number of halfway points and other points in the cross-sectional view of the route;

FIG. 7A shows the route on a map divided into small areas by a mesh;

FIG. 7B shows an entering point and a leaving point in a small area A in the map in the cross sectional view of the route;

FIG. 7C shows the highest point in the small area A in the map in the cross sectional view of the route;

FIG. 7D shows the guidance line connecting the entering point, the highest point and the leaving point in the small area A in the map in the cross sectional view of the route;

FIG. 8A shows the route from the start point to the destination point in the cross-sectional view;

FIG. 8B shows a point where a slope of the terrain changes from upward to downward in the cross sectional view of the route;

FIG. 8C shows the guidance line fittingly drawn on the terrain in the cross sectional view;

FIG. 9A shows an illustration of a view of the route ahead from a commanding position;

FIG. 9B shows an illustration of a view of the route ahead and a guidance arrow from the commanding position; and

FIG. 9C shows an illustration of a view of the route ahead extrapolatingly shown on the map from the commanding position.

### DETAILED DESCRIPTION OF THE PREFERRED EMBODIMENTS

An embodiment of the present invention is described with reference to the drawings. This navigation system of the present invention is intended for use in a vehicle such as an automobile or the like.

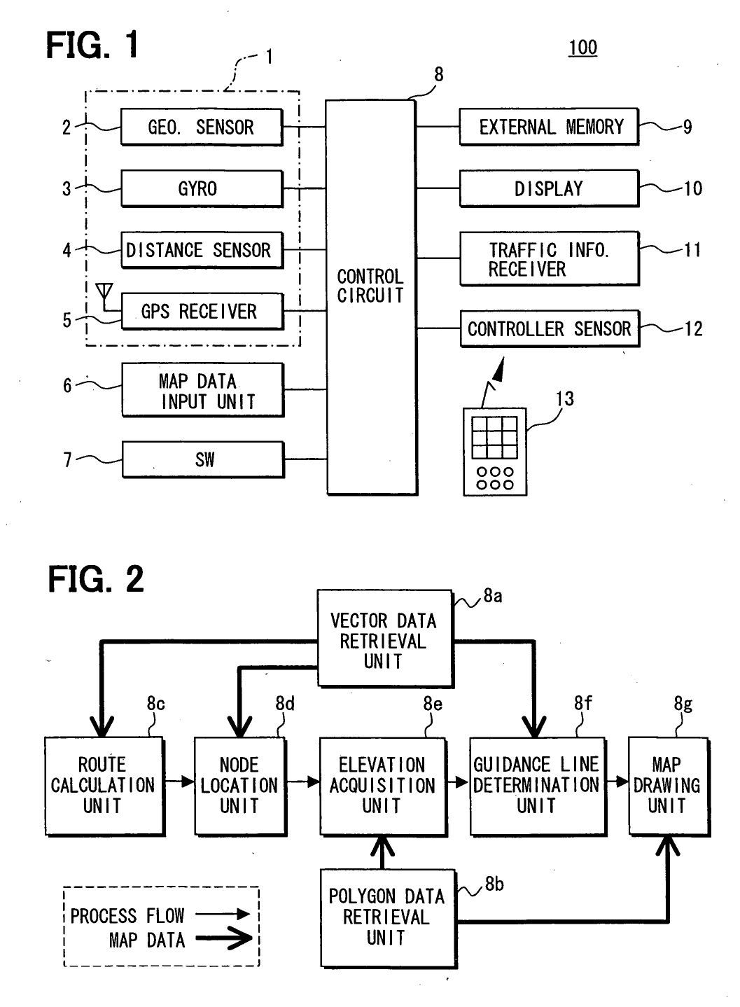

FIG. 1 shows a block diagram of the navigation system in an embodiment of the present invention. The navigation system 100 includes a position detector 1, a map data input unit 6, operation switches 7, an external memory 9, a display 10, a traffic information receiver 11, a remote controller sensor 12, a remote controller 13, and a control circuit 8 that connects all those components. The control circuit 8 is made from a well-known type computer and includes a CPU, a ROM, a RAM, an I/O as well as a bus line that connects those elements.

The position detector 1 includes a geomagnetism sensor 2, a gyroscope 4, a distance sensor 4, and a Global Positioning System (GPS) receiver 5. These sensors and devices includes errors of different natures, thereby enabling a compensation of the error by an exchange of measurement data with each other. The accuracy of the sensors/devices is taken into account for measurement by a combination of some of those sensors and/or devices, and other sensors such as a steering rotation sensors and/or a wheel sensor may also be used.

The map data input unit 6 is used to input map data such as map matching data, vector map data for drawing a guidance line, map data for drawing various maps or the like. These map data are provided in various kinds of media such as a CD-ROM, a DVD-ROM as well as a memory card, a hard disk or the like.

Next, the vector map data including link data, node data and drawing data is described. Links and nodes are defined as geometrical elements with two points attached on both ends that corresponds to a crossing, a branch point or the like of a road. Roads in a real world are geometrically represented by the links and nodes. The link data includes a link ID, a link length, coordinates (e.g., latitude and longitude) of both end points, road name, road type (interstate, state road, local road, or the like), road width and the like.

The node data includes a node ID, node coordinate (e.g., latitude and longitude), connecting link IDs that designate all links that share the node as an end point, and node attribute that designates a node type such as an intersection, a branch point or the like. In this manner, the vector map data includes coordinates as an identification of location.

The drawing data is used to draw a map. The drawing data is stored as collection of mesh of small areas in the map. The drawing data includes shapes of the geographical features such as a sea, a lake, a pond, a mountain as well as facilities, a road, a crossing, a branch point defined by the position (coordinates such as latitude and longitude) and the elevation with accompanying terrain data in 3D polygon or the like. In this manner, the drawing data includes location coordinates as well as the elevation of the location. In addition, the 3D polygon is used to describe the roads and the buildings in a three-dimensional map.

The operation switches 7 are, for example, disposed as touch switches or mechanical switches on the display 10, and used for inputting various kinds of input. The display 10 is a color display for displaying a vehicle position mark at a position derived from the position detector 1 on a map drawn by using the drawing data inputted from the map data input unit 6 with a guidance line placed thereon.

The navigation system 100 displays an optimum route to a destination from a current position or a start point specified by user's input from the operation switches 7 and the remote controller 13 based on an algorithm such as Dijkstra method or the like. The navigation system 100 in the present embodiment uses the three-dimensional map in route guidance described above by using the 3D polygons.

FIG. 2 shows a block diagram of functional units in the control circuit 8. A vector data retrieval unit 8a retrieves the vector map data along a calculated guidance line from the map data input unit 6 upon receiving inputs of the current position or the start point and the destination. A polygon data retrieval unit 8b retrieves the drawing data including 3D polygon data from the map data input unit 6.

A route calculation unit 8c uses the vector map data to calculate the optimum route from the current position/start point to the destination, and outputs the map data along the optimum route to a node location unit 8d. The node location unit 8d determines position information of characteristic points on the optimum route.

An elevation acquisition unit 8e determines elevation information of the characteristic points on the optimum route based on the corresponding 3D polygon data. In this manner, the elevation of the characteristic points along the route is determined. A guidance line determination unit 8f determines a drawing position of the guidance line in the three-dimensional map based on the elevation information determined by the elevation acquisition unit 8e. A map drawing unit 8g draws the three-dimensional map by using the 3D polygons as well as the guidance line at the position determined by the guidance line determination unit 8f.

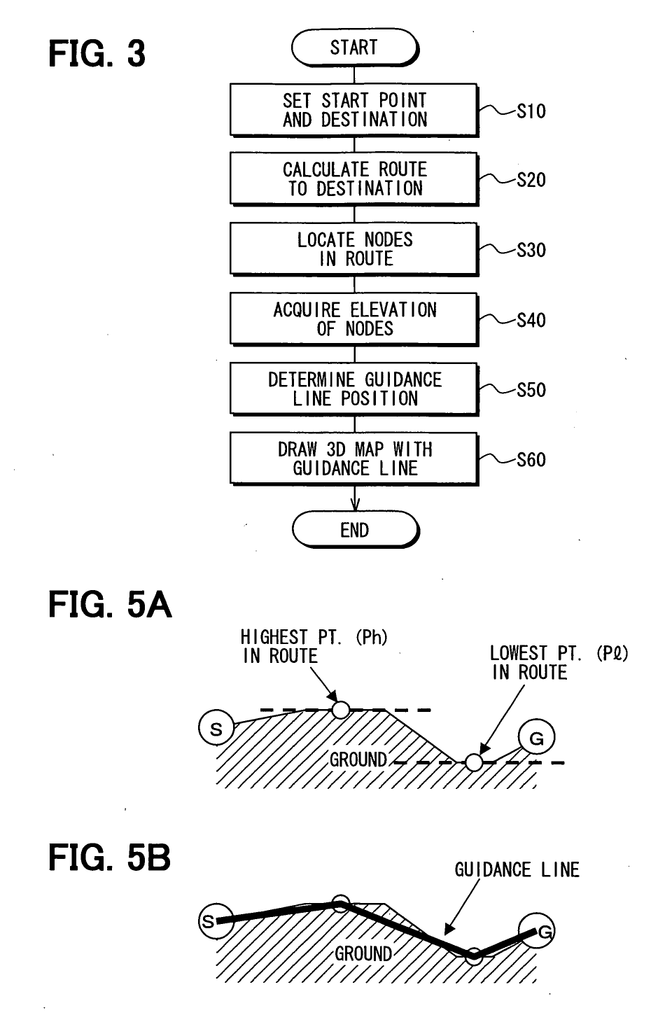

Next, a guidance process of the navigation system 100 is described with reference to a flowchart in FIG. 3.

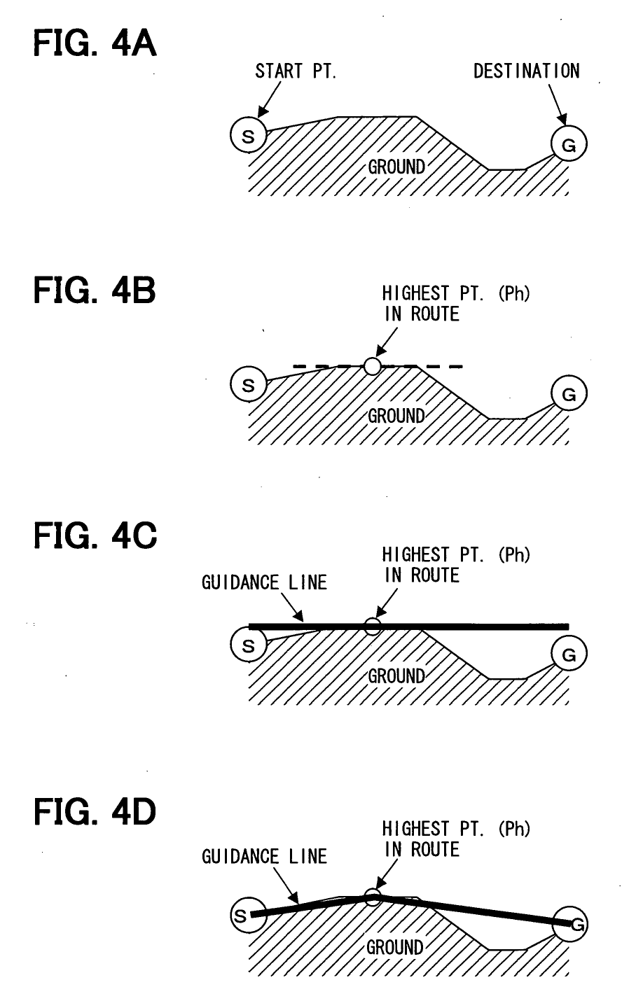

In step S10, a start point (or a current position) and a destination are determined. In step S20, an optimum route to the destination is calculated. In step S30, characteristic points are located on the optimum route with their position information. In FIG. 4A, a cross-sectional view of the optimum route from the start point to the destination is shown. In this case, the position information of the characteristic point includes the position information of a highest point (Ph) on the optimum route as shown in FIG. 4B.

In step S40, the elevation of the characteristic point determined in step S30 is retrieved from the 3D polygon data. In step S50, a drawing position of the guidance line in the three-dimensional map is determined based on the information from step S40. In this manner, the guidance line is always drawn on a road (i.e., above a surface of a ground) in the three dimensional map as shown in FIG. 4C.

In step S60, a guidance map is drawn with the guidance line at the position determined in step S50 in the three-dimensional map. The map and the guidance line is “scrolled” as the position of the vehicle proceed to the destination.

The navigation system 100 in the present embodiment uses the 3D polygon data for determination of the elevation of the guidance line in the three-dimensional map, and thereby draws the guidance line in a non-submerging manner above the surface of the ground (i.e., the road) represented by the 3D polygons in the map.

(Modification 1)

FIG. 4C shows a guidance line drawn at the highest point (Ph) of the ground in the route in the cross-sectional view of the route. However, the guidance line may be drawn by connecting the start point (the current position), the highest point (Ph) and the destination as shown in FIG. 4D. In this manner, the guidance line on a hilly ground in the three-dimensional map becomes less “detached” from the surface of the ground (i.e., the road).

(Modification 2)

The guidance line may be drawn as the lines connecting the start point (the current position), the highest point (Ph) of the ground in the route, a lowest point (Pl) of the ground in the route, and the destination after locating those points as shown in FIGS. 5A and 5B. In this manner, the guidance line in the three-dimensional map becomes less detached or less sub-merging on the surface of the ground(i.e., the road).

(Modification 3)

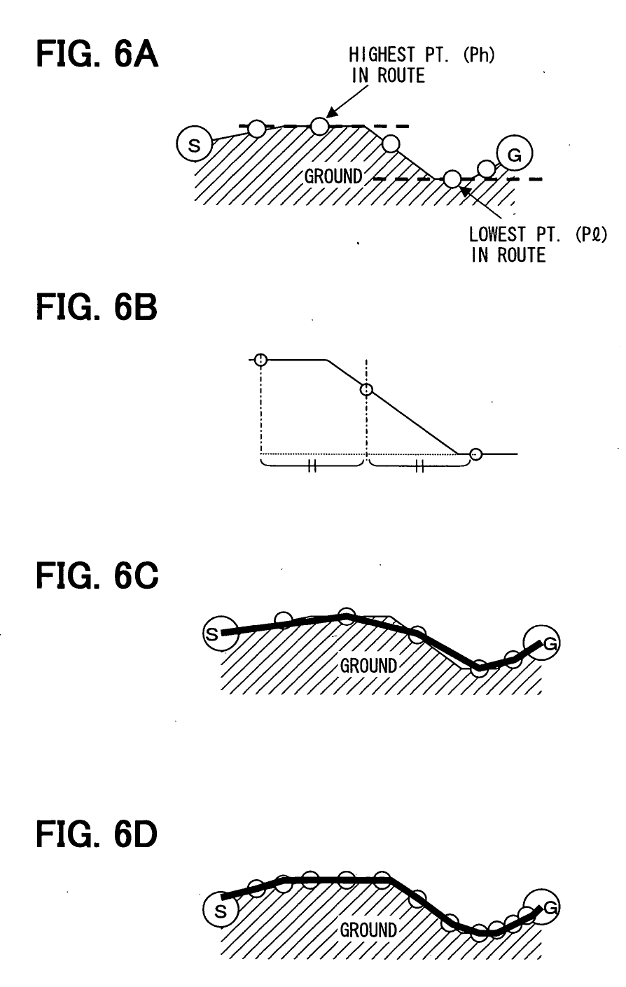

The guidance line may be drawn as the lines connecting additional points located between the highest/lowest points and the start/end points in the route. That is, as shown in FIGS. 6A and 6B, an additional point may be located as a halfway point between the highest and lowest points (Ph, Pl) in the route. The location of the halfway point is calculated by using the coordinates (latitudes and longitudes) of the two points. The elevation of the drawing position of the guidance line at the halfway point is calculated and determined based on the location coordinates of the halfway point. In this manner, the guidance line in the three-dimensional map is more suitably drawn on the surface of the ground (i.e., the road) as shown in FIG. 6C.

The divisions between the highest/lowest (Ph, Pl) and other points may be further increased in number for drawing the guidance line more fittingly on the ground as shown in FIG. 6D. The guidance line may also be drawn as an arc, or as a spline curve.

(Modification 4)

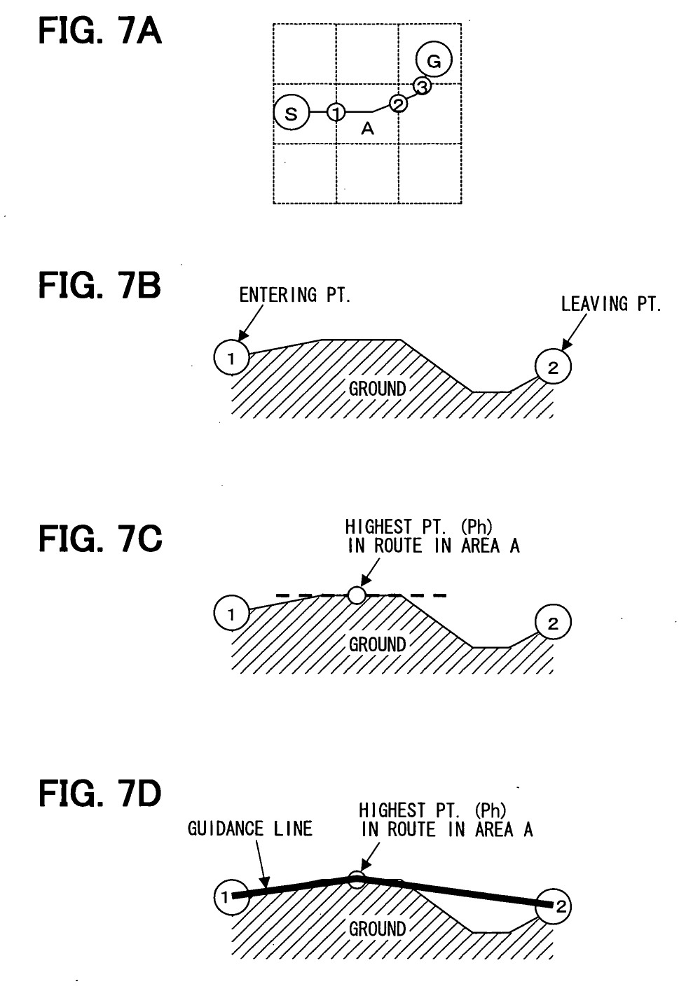

The area of the three-dimensional map may be divided into smaller areas as shown in FIG. 7A in order to decrease process load in the map drawing unit 8g to the navigation system 100.

In each of the small areas, the route is defined by using an entering point and a leaving point of the area, and the highest and lowest points (Ph, Pl) in the area. The guidance line in the area is drawn by using the elevation information at the positions of those points as the position information determined by the elevation acquisition unit 8e and the guidance line determination unit 8f.

The guidance line is drawn by the map drawing unit 8g based on the calculated positions in the route in the small area. In this manner, the process load in the navigation system 100 is decreased.

The example shown in FIG. 7A shows a route from the start point (S) to the destination (G) in a plurality of the small areas. In this case, the guidance line in an area A is drawn by using the elevation/location information of the entering point (1), the leaving point (2) and the highest point (Ph) in the area A as shown in FIGS. 7B, 7C, and 7D.

(Modification 5)

The guidance line in each of the small areas of the map may be further divided into small portions for more fitting on the surface of the ground (i.e., the road) in the three-dimensional map. The guidance line may also be drawn as an arc, or as a spline curve.

(Modification 6)

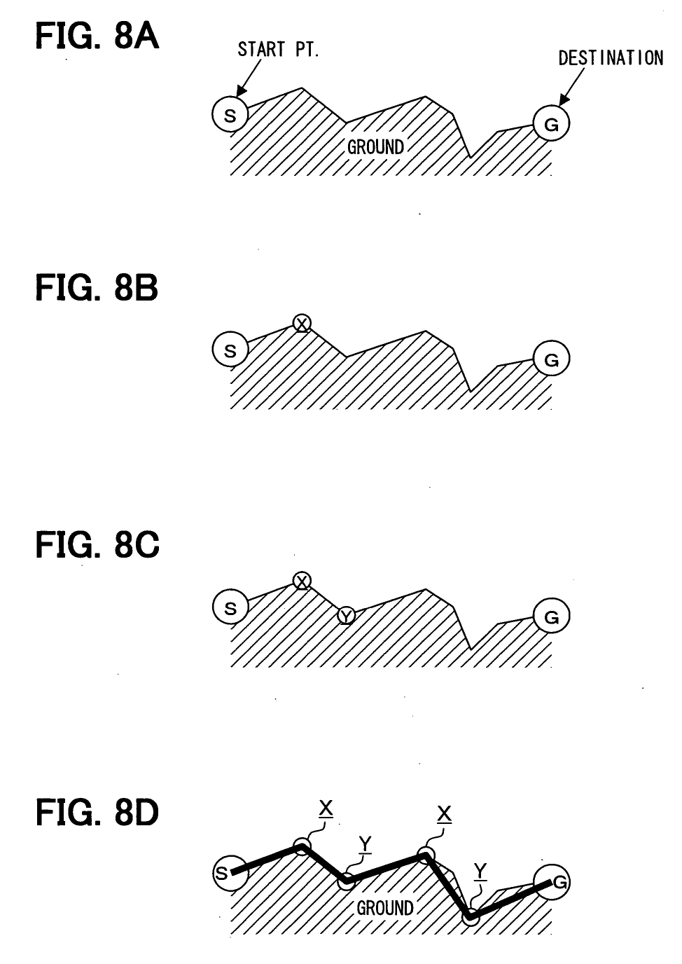

The guidance line may be drawn by locating characteristic points that is defined by change in an angle of slopes. For example, a characteristic point X may be defined as a point where the slope of the ground changes from ascent to descent, as shown in FIGS. 8A and 8B. A characteristic point Y may be defined as a point where the slope of the ground changes from descent to ascent as shown in FIG. 8C. In this manner, the characteristic points in the route may be used for drawing the guidance line fittingly on the ground in the three-dimensional map as shown in FIG. 8D.

(Modification 7)

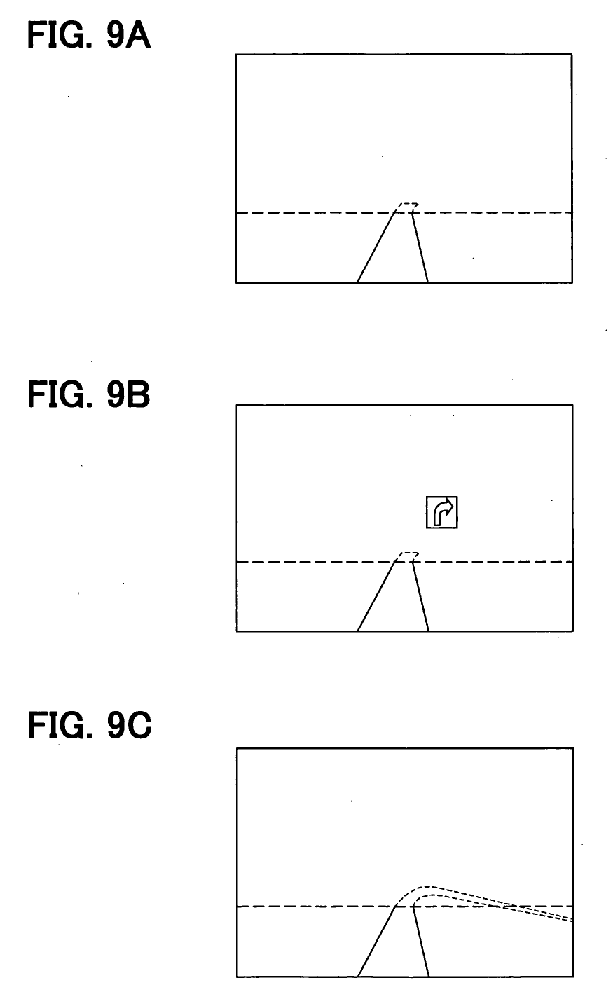

A road ascending a hilly ground in front of the vehicle is shown in the three-dimensional map, as long as the road is on this side of the hill. That is, the road ahead of a summit of the hilly ground cannot be seen in the three-dimensional map. This situation cause an inconvenience for a driver of a vehicle or the like, because of the unpredictability of the road ahead of the summit. The road ahead of the summit may be shown with a dotted line in the navigation system 100 as the vehicle approaches a summit of a slope as shown in FIG. 9A. In this manner, the driver can recognized a direction of the road ahead of the summit of the slope.

Further, the direction of the route may be represented by an arrow sign in the map as shown in FIG. 9B. Furthermore, the road ahead of the summit of the slope may be drawn as a virtual image in the map as shown in FIG. 9C. In this manner, the road ahead of the summit of the slope can be recognized by the driver of the vehicle in advance. Furthermore, a viewpoint of the three-dimensional map may be raised as the vehicle approaches the summit of the slope.

Although the present invention has been fully described in connection with the preferred embodiment thereof with reference to the accompanying drawings, it is to be noted that various changes and modifications described above are apparent to those skilled in the art.

Such changes and modifications are to be understood as being within the scope of the present invention as defined by the appended claims.

What is claimed is:

1. A map display system having map data of three dimensions for displaying a three-dimensional map together with a representation of a vector map data comprising:
an elevation acquisition means for acquiring an elevation of a route between a start point to an end point in said three-dimensional map;
a position determination means for determining a position of a guidance line in said three-dimensional map based on the elevation of the route; and
a map drawing means for drawing said three-dimensional map with the guidance line by using the position of the guidance line, wherein the guidance line represents the route in said three-dimensional map by using said vector map data.

2. The map display system according to claim 1 further comprising a node location means for determining a location of a node in the route based on a predetermined rule in a two-dimensional space in said map data,
wherein the position of the guidance line is defined by the elevation and the location of the node.

3. The map display system according to claim 2,
wherein the node location means locates the node at a highest point in the route, and
the map drawing means draws said three-dimensional map with entirety of the guidance line positioned at the elevation of the node at the highest point in the route.

4. The map display system according to claim 2,
wherein the node location means locates one node at each of the start point and the end point in the route,
the node location means locates one node of at least one of a highest point and a lowest point in the route between the start point and the end point when the start point and the end point are neither of the highest point and the lowest point in the route, and
the map drawing means draws said three-dimensional map with the guidance line linking the nodes located by the node location means.

5. The map display system according to claim 2,
wherein said map data represents a portion of said three-dimensional map,
the node location means locates one node at each of an entering point and a leaving point of the route in the portion of said three-dimensional map as well as the start point and the end point in the route,
the node location means locates one node at at least one of a highest point and a lowest point between the entering point and the leaving point of the route in the portion of said three-dimensional map when the entering point and the leaving point are neither of the highest point and the lowest point in the route, and
the map drawing means draws said three-dimensional map with the guidance line linking the nodes located by the node location means.

6. The map display system according to claim 2,
wherein the node location means locates one node at each of the start point and the end point in the route,
the node location means locates one node at a bend point between the start point and the end point where an inclination between the bend point and the start point and an inclination between the bend point and the end point are reverse, and
the map drawing means draws said three-dimensional map with the guidance line linking the nodes located by the node location means.

7. The map display system according to claim 4,
wherein the node location means locates one node at a bend point between the start point and the end point where an inclination between the bend point and the start point and an inclination between the bend point and the end point are reverse,
the node location means further locates a plurality of nodes between the start point, the bend point and the end point, and
the map drawing means draws said three-dimensional map with the guidance line linking the nodes located by the node location means.

8. The map display system according to claim 5,
wherein the node location means further locates at least one node in each of portions of the route between the entering point and the leaving point divided by the bend point, and
the map drawing means draws said three-dimensional map with the guidance line linking the nodes located by the node location means.

9. The map display system according to any one of claims 1 to 8,
wherein the start point includes a current position of a route guidance, and
the end point includes a destination of a route guidance.
